(19) United States
(12) Patent Application Publication
(10) Pub. No.: US 2009/0083355 A1
(43) Pub. Date: Mar. 26, 2009

(54) Convolution integral calculation apparatus

(76) Inventor: Tamiki Takemori, Shizuoka (JP)

Correspondence Address: DRINKER BIDDLE & REATH (DC), 1500 K STREET, N.W., SUITE 1100, WASHINGTON, DC, 20005-1209, US

(21) Appl. No.: 11/920,438

(22) PCT Filed: May 23, 2006
(86) PCT No.: PCT/JP2006/310248

§ 371 Date: Nov. 15, 2007

(30) Foreign Application Priority Data
May 25, 2005 (JP) 2005-152821

(51) Int. Cl. G06F 17/15

(52) U.S. Cl. 708/420

(57) ABSTRACT

A convolution integrator that can be used favorably to prepare, at high speed, a computer generated hologram that can reproduce a reproduction image formed by reproduction points at various distances and differing in initial phase is provided. A plurality of element processors PE are practically cascade-connected. Each element processor PE includes: a constant generator 91A, outputting a propagation function value that is generated based on a coordinate value Z and an initial phase value P; a multiplier 92, multiplying the propagation function value and a luminance value I and outputting the product value; an adder/subtractor 93, performing addition/subtraction on the product value and a hologram time series signal PDin and outputting the sum/difference value; and a register 94, receiving, holding, and then outputting the sum/difference value as a hologram time series signal PDout. The hologram time series signal PDout, output from a register 94 of an element processor of a preceding stage that is cascade-connected, is input as the hologram time series signal PDin into an adder/subtractor 93 of an element processor of a subsequent stage.

### TECHNICAL FIELD

The present invention relates to a convolution integrator that performs a convolution integration operation in real time, and particularly relates to a convolution integrator enabled to perform a convolution integration operation favorably in a process of preparing a computer generated hologram for reproducing a three-dimensional object image.

### BACKGROUND ART

Holographic arts are being noted as arts for displaying three-dimensional images of objects. Holographic arts are constituted of holography preparation arts for preparing holograms that contain three-dimensional information on objects and holography displaying arts for reading three-dimensional information on objects recorded by hologram preparation arts and displaying three-dimensional images of the objects. A hologram is prepared by capturing an interference pattern formed by interference of an object light, resulting from coherent light illuminated onto and reflected by an actual object, with a reference light. A hologram can also be prepared by calculation. A hologram prepared by calculation is called a computer generated hologram. A reproduction image is obtained by illuminating illumination light onto a prepared hologram.

In regard to a hologram preparing apparatus for preparing a hologram by calculation, an apparatus that calculates a spherical wave (zone plate) on a hologram surface for each bright point (reproduction point) of a reproduction image and prepares a hologram by adding these spherical waves on the hologram surface has been proposed (this art shall be referred to hereinafter as “Conventional Example 1”). Also, as an arrangement, which uses fast Fourier transform and with which a reproduced object is formed of a plurality of planar objects, an apparatus that executes convolution integration of a propagation function (zone plate) that is in accordance with a distance from each plane to a hologram and the plane corresponding to each propagation function and performs addition on the hologram surface has been proposed (this art shall be referred to hereinafter as “Conventional Example 2”).

With Conventional Example 1, (a) distances from a single reproduction point to all points (discrete points) on the hologram surface are calculated, (b) each distance thus obtained is divided by a wavelength, (c) the fractional part of each division result is multiplied by twice the circular constant to determine a phase angle for each discrete point on the hologram surface, (d) a real component is calculated as the cosine of each phase angle, an imaginary component is calculated as the sine of each phase angle, and (e) each real component and each imaginary component is multiplied by a luminance value corresponding to an amplitude of light at the reproduction point. The calculation process of the above steps (a) to (e) is performed for each reproduction point and thereafter, addition is performed for each discrete point on the hologram surface. The same calculation as that of Conventional Example 1 is also performed in calculating the propagation functions in Conventional Example 2.

Although such a computer generated hologram can be prepared by calculation by software, because the calculation amount is enormous, a large amount of time is required for preparation. Meanwhile, a computer generated hologram can also be prepared by hardware (see, for example, Patent Documents 1 and 2). In comparison to preparation by software, the time required for preparation by hardware is short.

FIG. 9 is a block diagram of a conventional hologram preparing apparatus. With the hologram preparing apparatus shown in this figure, propagation functions that differ according to distance between a reproduction point on a reproduction image and a discrete point on a hologram surface are not calculated each time, but propagation functions that are in accordance with distances are calculated and stored in a memory 1 in advance. Also, coordinate values (X, Y, Z) of a reproduction point and a luminance value I are input from the exterior into the hologram preparing apparatus. Here, it shall be deemed that an X-axis and a Y-axis are parallel to the hologram surface. Two-dimensional address values on the hologram surface, which are generated and output by a two-dimensional address generator 2, and the input coordinate value Z are input into a selector 3, and a propagation function that is in accordance with the two-dimensional address values and the coordinate value Z is selected from among the propagation functions stored in the memory 1.

The propagation function selected by the selector 3 and the input luminance value I are multiplied by a multiplier 4. The two-dimensional address values, output from the two-dimensional address generator 2, and the input coordinate values X and Y are input into a adder/subtractor 5 and are subject to addition/subtraction by the adder/subtractor 5. The addition/subtraction result becomes an address in a hologram memory 6. The hologram memory 6 has addresses corresponding to positions on the hologram surface. Data stored at the address of the hologram memory 6 and the multiplication result of the multiplier 4 are subject to addition/subtraction by an adder/subtractor 7, and the addition/subtraction result is renewingly stored at the address of the hologram memory 6. A convolution integration operation is thus performed on the propagation functions and the luminance values of the reproduction points and the operation results are stored in the hologram memory 6.

FIG. 10 is a block diagram of a conventional hologram preparing apparatus disclosed in Patent Document 2. FIG. 11 is a block diagram of an element processor included in the hologram preparing apparatus. The hologram preparing apparatus shown in this figure prepares a computer generated hologram by performing a convolution integration operation using a plurality of element processors PE and is constituted of a counter 10, a memory 20, a memory 30, element processors (PEs) PE_{0, 0} to PE_{n, m}, shift registers (SRs) SR₁ to SRₙ, and a D/A converter 50.

The counter 10 receives and counts pulses of a clock signal PCLK and outputs count values as coordinate values X, Y. The memory 20 stores luminance values I according to the respective coordinate values X, Y, receives the coordinate values X, Y output from the counter 10 as an address, and outputs the data stored at the corresponding address as a luminance Value I. The memory 30 has coordinate values Z stored in correspondence to the respective coordinate values X, Y in advance, receives the coordinate values X, Y output from the counter 10 as an address, and outputs the data stored at the corresponding address as a coordinate value Z. The coordinate values (X, Y, Z) express coordinate values of a reproduction point. The clock signal PCLK, the luminance value, output from the memory 20, and the coordinate value Z, output from the memory 30, are input simultaneously into the respective element processors PE_{j, i} (j=0 to n, i=0 to m).

The ((n+1)×(m+1)) element processors PE are mutually the same in same arrangement. (m+1) element processors PE are connected in cascade to form a single column, (n+1) columns are formed as a whole, and shift registers SR are respectively inserted between columns and connected in cascade. The element processors PE_{j, i} (j=0 to n, i=0 to m) respectively correspond to the ((n+1)×(m+1)) discrete points on the hologram surface. Here, it shall be deemed that there are H discrete points in a horizontal direction and V discrete points in a vertical direction on the hologram surface. In this case, each of the shift registers SRⱼ (j=1 to n) is an (H−(m+1))-stage shift register. As shown in FIG. 11, each element processor PE has a memory 91, a multiplier 92, an adder/subtractor 93, and a register 94. The memory 91 stores propagation functions corresponding to the respective coordinate values Z, receives a coordinate value Z, output from the memory 30, as an address, and outputs data stored at the corresponding address as the propagation function. The multiplier 92 receives the propagation function output from the memory 91 and the luminance value I output from the memory 20, multiplies the propagation function and the luminance value I, and outputs a product value that is the multiplication result. The adder/subtractor 93 receives the product value output from the multiplier 93 and a hologram time series signal PDin, output and arriving from an element processor PE or a shift register SR of a preceding stage, performs addition/subtraction on the product value and the hologram time series signal PDin, and outputs a sum/difference value that is the addition/subtraction result. The register 94 receives and holds the sum/difference value, output from the adder/subtractor 93 at a rising edge time of the clock signal PCLK, and outputs the sum/difference value as a hologram time series signal PDout to a subsequent element processor PE or shift register SR.

The element processor PE_{n, m} of the final stage outputs the result of the convolution integration operation as a hologram time series signal. The D/A converter 50 receives' the value (digital value) of the convolution integration operation result, performs conversion of the digital value to an analog value, and outputs the analog value. The hologram preparing apparatus can thus prepare a computer generated hologram at high speed by the convolution integration operation. A computer generated hologram that has been prepared by a hologram preparing apparatus such as that described above is generally presented to a transmission or reflection type spatial optical modulation element, and a reproduction image is obtained by an illumination light being illuminated onto the spatial optical modulation element.

FIG. 12 is a diagram of a real image reproducing optical system that uses a transmission or reflection type spatial optical modulation element. When a transmission type spatial optical modulation element 101 is used, a parallel light L is made incident as an illumination light on the spatial optical modulation element 101 from a side opposite the side of an observer 105, and in the process of transmission of the illumination light made incident on the spatial optical modulation element 101, both or one of either of the amplitude and the phase of the illumination light is or are modulated according to each pixel. When a reflection type spatial optical modulation element 101 is used, a parallel light is made incident as an illumination light on the spatial optical modulation element 101 from the same side as the side of the observer 105, and in the process of reflection of the illumination light made incident on the spatial optical modulation element 101, both or one of either of the amplitude and the phase of the illumination light is or are modulated according to each pixel. By means of this spatial optical modulation element, a three-dimensional object reproduction image 104, which is a real image, is observed by the observer 105.

FIG. 13 is a diagram of a virtual image reproducing optical system that uses a transmission or reflection type spatial optical modulation element.

When a transmission type spatial optical modulation element 201 is used, a parallel light is made incident as an illumination light on the spatial optical modulation element 201 from a side opposite the side of an observer 205, and in the process of transmission of the illumination light made incident on the spatial optical modulation element 201, both or one of either of the amplitude and the phase of the illumination light is or are modulated according to each pixel. When a reflection type spatial optical modulation element 201 is used, a parallel light L′ is made incident as an illumination light on the spatial optical modulation element 201 from the same side as the side of the observer 205, and in the process of reflection of the illumination light made incident on the spatial optical modulation element 201, both or one of either of the amplitude and the phase of the illumination light is or are modulated according to each pixel. By means of this spatial optical modulation element, a three-dimensional object reproduction image 204 or 206, which is a virtual image, is observed by the observer 205.

With each of the reproducing optical systems shown in FIGS. 12 and 13, a lens 102 or 202 is, in many cases, inserted to compensate for an inadequacy of resolution of the spatial optical modulation element 101 or 201.

Patent Document 1: Japanese Published Unexamined Patent Application No. H10-268739

Patent Document 2: Japanese Published Unexamined Patent Application No. 2000-242630

### DISCLOSURE OF THE INVENTION

### Problems to be Solved by the Invention

With the reproduction optical system shown in FIG. 12 or 13, the following problem occurs when no consideration whatsoever is taken in regard to an initial phase of each bright point (reproduction point) of a three-dimensional object reproduction image that is to be reproduced. For example, when it is deemed that the fractional part is equal for the respective division results (and, for example, the fractional part is truncated) in the division of step (b) described for Conventional Example 1, the phase angles of the respective discrete points on the hologram surface that are determined in step (c) take on a fixed value.

With the reproduction optical system shown in FIG. 12 or 13, when the phase angles of the respective discrete points on the hologram surface presented to the spatial optical modulation element 101 or 201 have a fixed value, inverse Fresnel transform wavefronts and Fresnel transform wavefronts from the reproduction image are generated at a rear focal plane 103 or 203 of the lens 101 or 202. These wavefronts can be considered as being Fourier spectra of the hologram pattern. As a general characteristic of a Fourier spectrum, light components of high amplitude are generated as a zeroth order light component and components near the zeroth order and light components of low amplitude are generated at peripheral portions. That is, at the rear focal plane 103 or 203, the light intensity distribution is localized to light components of high intensity.

When a three-dimensional object reproduction image is observed in the reproduction optical system shown in FIG. 12, because the light intensity distribution at the rear focal plane 103 of the lens 102 becomes a new light source and reproduces a reproduction image, a light component that is made incident on a viewpoint of the observer 105 can be regarded to be a light component on the rear focal plane 103 along an extension of a straight line joining the viewpoint and a portion of the object. When the light intensity distribution at the rear focal plane 103 is localized to light components of high intensity, the reproduction image is also observed as being localized in intensity. Thus, in cases where a three-dimensional object that is to be reproduced has a uniform luminance distribution, a reproduction image of such an object having an arbitrary pattern will be unclear.

Meanwhile, with the reproduction optical system shown in FIG. 13, because a pupil of the observer 205 acts as a spectral transmission mask and exhibits a filtering function, faithful reproduction of a three-dimensional object is impaired.

Thus, in order to obtain a clear and faithful three-dimensional object reproduction image, it becomes important to take into consideration the initial phases of the respective bright points (reproduction points) of the three-dimensional object reproduction image to be reproduced and to uniformalize the light intensity distribution at the rear focal plane 103 or 203 of the lens 102 or 202. For this purpose, for example, using the fractional part of each division result as effective numerals instead of truncating it in the division of step (b) described for Conventional Example 1 can be considered. The same applies to a hologram preparing apparatus for preparing a computer generated hologram.

However, when in a hologram preparing apparatus, the fractional part of each division result is used as effective numerals instead of truncating it, an unintended bias is generated in the distance between each bright point and each pixel position on the hologram in many cases and this use of the fractional part thus cannot be applied in a simple manner.

The present invention has been made to resolve the above problems and an object thereof is to provide a convolution integrator that can be used favorably to prepare, at high speed, a computer generated hologram that can reproduce a reproduction image formed by reproduction points at various distances and differing in initial phase.

### Means for Solving the Problem

A convolution integrator according to the present invention is a convolution integrator that includes a plurality of practically cascade-connected element processors, and each of the plurality of element processors includes: (1) a constant generator, receiving a first input value and a second input value, generating a predetermined value based on the first input value and the second input value, and outputting the predetermined value; (2) a multiplier, receiving the predetermined value, output from the constant generator, and a third input value, multiplying the predetermined value and the third input value, and outputting a product value resulting from the multiplication; (3) an adder/subtractor, receiving the product value, output from the multiplier, and a fourth input value, performing addition/subtraction of the product value and the fourth input value, and outputting a sum/difference value resulting from the addition/subtraction; and (4) a register, receiving, holding, and outputting the sum/difference value output from the adder/subtractor; and the sum/difference value, output from the register of an element processor that is cascade-connected at a preceding stage, is input as the fourth input value into the adder/subtractor of an element processor at a subsequent stage to perform convolution integration of the predetermined value and the third input value.

With this convolution integrator, the plurality of element processors are cascade-connected directly or via shift registers. At each element processor, the predetermined value, output from the constant generator based on the first input value and the second input value, and the third input value are multiplied by the multiplier. The product value and the fourth input value are subject to addition/subtraction by the adder/subtractor, and the sum/difference value is held by the register. The sum/difference value, output from the register of an element processor that is cascade-connected at a preceding stage, is input as the fourth input value into the adder/subtractor of an element processor at a subsequent stage. Convolution integration of the predetermined value and the third input value is thus performed. Moreover, because the predetermined value is output from the constant generator based on the first input value and the second input value, the convolution integrator according to the present invention can be used favorably to prepare, at high speed, a computer generated hologram that can reproduce a reproduction image formed by reproduction points at various distances and differing in initial phase.

Preferably with the convolution integrator according to the present invention, the constant generator includes: (a) a first memory, receiving the first input value and outputting a first intermediate value according to the first input value; (b) an adder, receiving the first intermediate value, output from the first memory, and the second input value, adding the first intermediate value and the second input value, and outputting a second intermediate value that is the result of the addition; and (c) a second memory, receiving the second intermediate value, output from the adder, and outputting the predetermined value according to the second intermediate value. In this case, the first intermediate value that is in accordance with the first input value is output from the first memory, the second intermediate value is output upon addition of the first intermediate value and the second input value by the adder, and the predetermined value that is in accordance with the second intermediate value is output from: the second memory.

Preferably with the convolution integrator according to the present invention, the second input value is a 2-bit data, and the constant generator includes: (a) a memory, receiving the first input value and an upper bit of the second input value and outputting an intermediate value according to the first input value and the value of the upper bit of the second input value; and (b) a sign adjuster, receiving the intermediate value, output from the memory, and a lower bit of the second input value, adjusting the sign of the intermediate value according to the value of the lower bit of the second input value, and outputting the sign-adjusted intermediate value as the predetermined value. In this case, the intermediate value that is in accordance with the first input value and the upper bit of the second input value is output from the memory, and at the sign adjuster, the sign of the intermediate value is adjusted according to the value of the lower bit of the second input value and the sign-adjusted intermediate value is output as the predetermined value.

The convolution integrator according to the present invention is used favorably for preparing a computer generated hologram. In this case, the first input value is a reproduction distance, the second input value is an initial phase value, the predetermined value output from the constant generator is a propagation function value that is in accordance with the reproduction distance and the initial phase value, the third input value is a luminance value, and the fourth input value and the convolution integration result are hologram time series signals.

Preferably, the convolution integrator according to the present invention further includes: (1) an address generator, successively generating and outputting a plurality of addresses; (2) a first signal value generator, receiving an address output from the address generator and outputting a first signal value, that is in accordance with the address, to each of the plurality of element processors; (3) a second signal value generator, receiving an address output from the address generator and outputting a second signal value, that is in accordance with the address, to each of the plurality of element processors; and (4) a third signal value generator, receiving an address output from the address generator and outputting a third signal value, that is in accordance with the address, to each of the plurality of element processors. Also, preferably, the second signal value generator includes a combinational gate circuit, generating and outputting the second signal value based on a data of a certain bit of the address output from the address generator.

### EFFECT OF THE INVENTION

With the present invention, a computer generated hologram, which can reproduce a reproduction image formed by reproduction points at various distances and differing in initial phase, can be prepared at high speed.

### BRIEF DESCRIPTION OF THE DRAWINGS

FIG. 1 is a block diagram of a convolution integrator according to a first embodiment;

FIG. 2 is a block diagram of an element processor PE in the convolution integrator according to the first embodiment;

FIG. 3 is a block diagram of an element processor PE in a convolution integrator according to a second embodiment;

FIG. 4 is a block diagram of an initial phase value generator 4 in a convolution integrator according to a third embodiment;

FIG. 5 is a diagram for describing bright point intervals and initial phase values of a reproduction image in the third embodiment;

FIG. 6 is a diagram for describing bright point intervals and initial phase values of a reproduction image in the third embodiment;

FIG. 7 is a diagram of a light intensity distribution at a rear focal plane of a lens in the case of the bright point intervals and the initial phase values shown in FIG. 5;

FIG. 8 is a diagram of a light intensity distribution at the rear focal plane of the lens in the case of the bright point intervals and the initial phase values shown in FIG. 6;

FIG. 9 is a block diagram of a conventional hologram preparing apparatus;

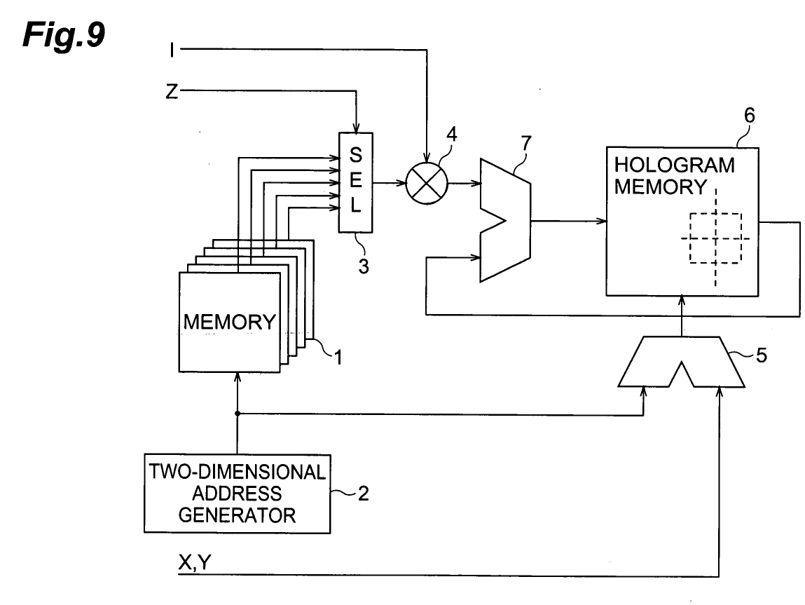

FIG. 10 is a block diagram of another conventional hologram preparing apparatus;

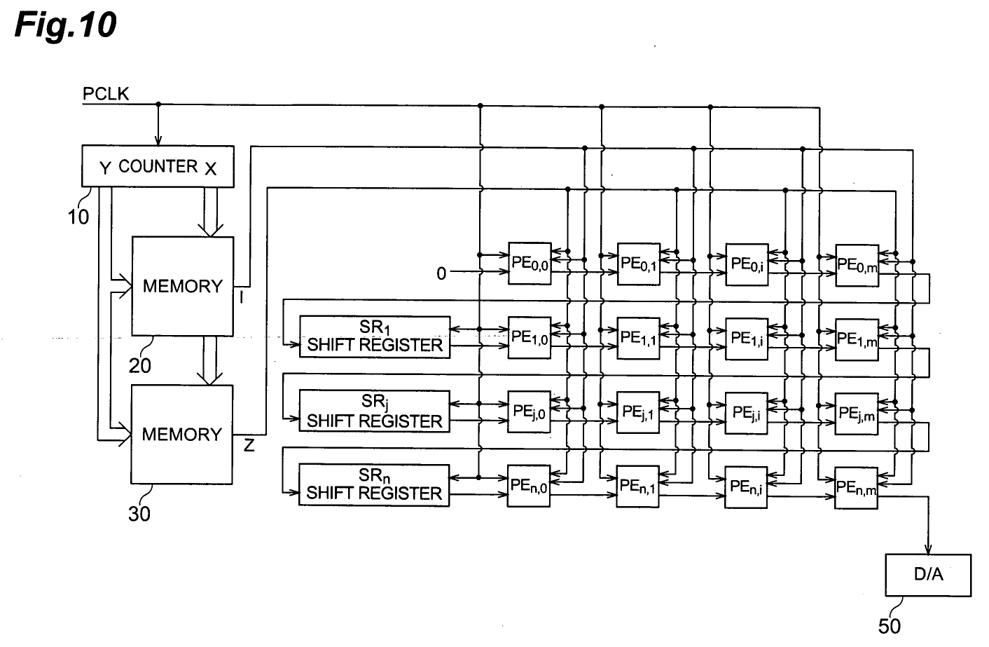

FIG. 11 is a block diagram of an element processor included in the hologram preparing apparatus shown in FIG. 10;

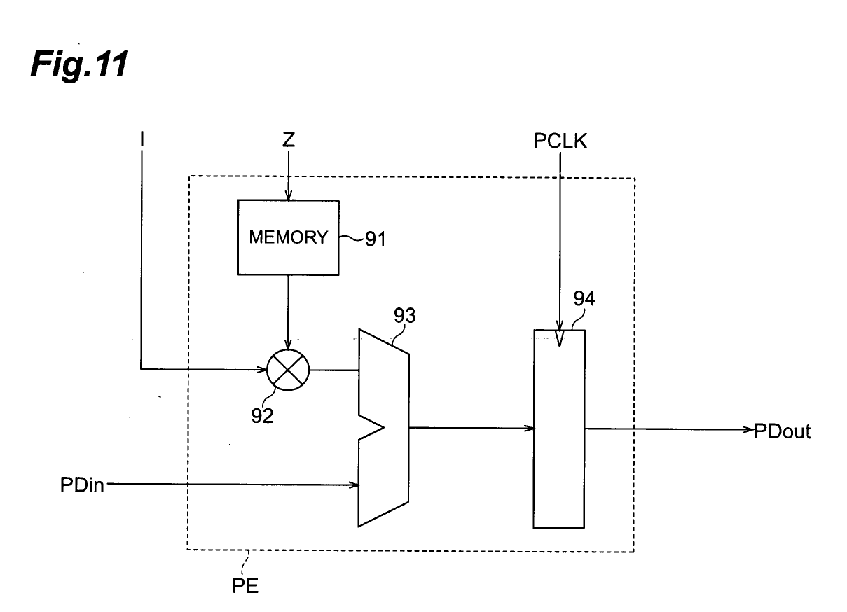

FIG. 12 is a diagram of a real image reproducing optical system that uses a transmission or reflection type spatial optical modulation element; and

FIG. 13 is a diagram of a virtual image reproducing optical system that uses a transmission or reflection type spatial optical modulation element.

### Description of Symbols

PE: Element processor
SR: Shift register
10: Counter
20: Memory
30: Memory
40: Initial phase value generator
41, 42: Counter
43: Combinational gate circuit
50: D/A converter
91A, 91B: Constant generator
92: Multiplier
93: Adder/subtractor
94: Register
95: Memory
96: Adder
97: Memory
98: Memory
99: Sign adjuster

### BEST MODES FOR CARRYING OUT THE INVENTION

Best modes for carrying out the present invention shall now be described in detail with reference to the drawings. In the description of the drawings, elements that are the same shall be provided with the same symbol and overlapping description shall be omitted. Also, in the following description, an X-axis and a Y-axis are defined in directions parallel to a hologram surface, and a Z-axis is defined in a direction perpendicular to the hologram surface.

### First Embodiment

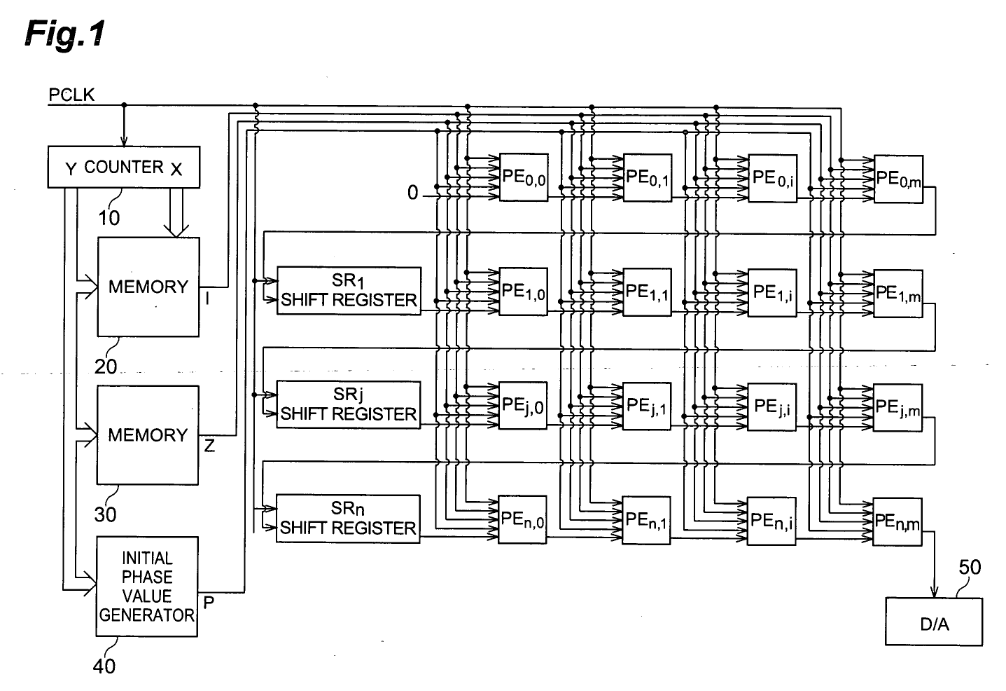

A first embodiment of a convolution integrator according to the present invention shall now be described. FIG. 1 is a block diagram of a convolution integrator according to the first embodiment. The convolution integrator according to the first embodiment is constituted of a counter 10 (address generator), a memory 20 (third signal value generator), a memory 30 (first signal value generator), an initial phase value generator 40 (second value signal generator), element processors PE_{0, 0} to PE_{n, m}, shift registers SR₁ to SRₙ, and a D/A converter 50. Of the above, the counter 10, the memory 20, the memory 30, the initial phase value generator 40, the element processors PE_{0, 0} to PE_{n, m}, and the shift registers SR₁ to SRₙ operate in synchronization to a common pixel clock signal PCLK.

The counter 10 receives the clock signal PCLK, counts the number of pulses of the signal, and outputs count values as coordinate values X and Y. The memory 20 has stored therein luminance values I, corresponding to respective coordinate values X and Y, receives the coordinate values X and Y output from the counter 10 as an address, and outputs data stored at the address as a luminance value I. The memory 30 has stored therein coordinate values Z, corresponding to the respective coordinate values X and Y, receives the coordinate values X and Y output from the counter 10 as an address, and outputs data stored at the address as a coordinate value Z. These coordinate values (X, Y, Z) express coordinate values of a bright point of a reproduction image, and the coordinate values (X, Y, Z) and the luminance values I corresponding to the respective addresses express the reproduction image.

The initial phase value generator 40 is constituted of a memory, having stored therein initial phase values P, corresponding to the respective coordinate values X and Y, receives the coordinate values X and Y output from the counter 10 as an address, and outputs data stored at the address as an initial phase value P. The clock signal PCLK, the luminance value I, output from the memory 20, the coordinate value Z, output from the memory 30, and the initial phase value P, output from the initial phase value generator 40, are input at the same time into each element processor PE_{j, i} (j=0 to n, i=0 to m).

The ((n+1)×(m+1)) element processors PE are mutually the same in arrangement. (m+1) element processors PE are connected in cascade to form a single column, (n+1) columns are formed as a whole, and the shift registers SR are respectively inserted between columns and connected in cascade. The element processors PE_{j, i} (j=0 to n, i=0 to m) respectively correspond to the ((n+1)×(m+1)) discrete points on the hologram surface. Here, it shall be deemed that there are H discrete points in the horizontal direction and V discrete points in the vertical direction on the hologram surface. In this case, each of the shift registers SRⱼ (j=1 to n) is an (H−(m+1))-stage shift register.

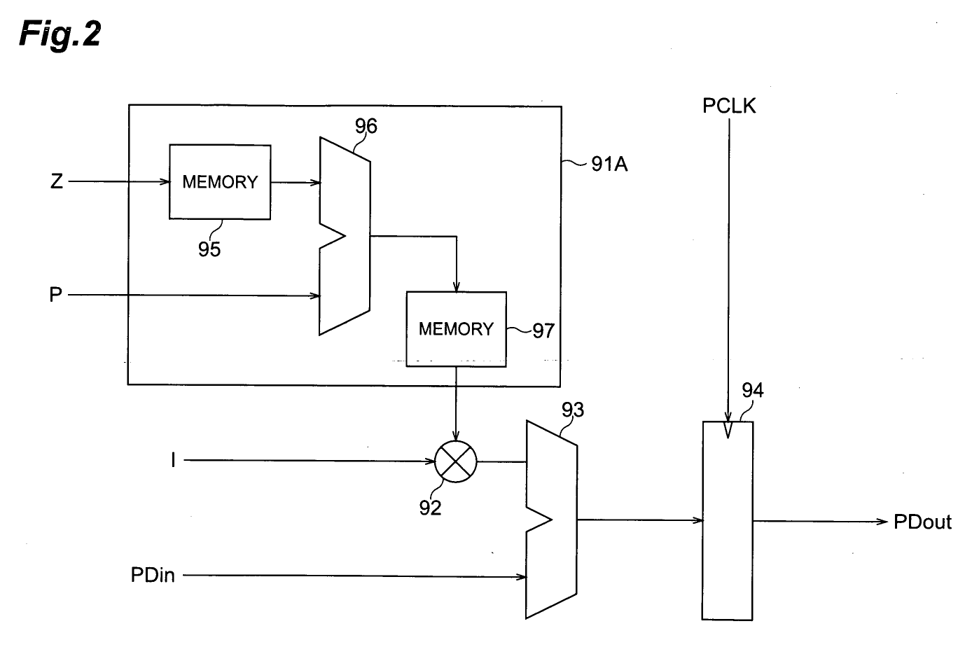

FIG. 2 is a block diagram of an element processor PE in the convolution integrator according to the first embodiment. The element processor PE has a constant generator 91A, a multiplier 92, an adder/subtractor 93, and a register 94. The constant generator 91A receives the coordinate value, that is, the reproduction distance Z (first input value) output from the memory 30, also receives the initial phase value P (second input value) output from the initial phase value generator 40, generates a predetermined value based on the reproduction distance Z and the initial phase value P, and outputs the predetermined value as a propagation function value.

The constant generator 91A includes a memory 95, an adder 96, and a memory 97. The memory 95 has stored therein propagation function phase constants, corresponding to respective reproduction distances Z, receives the coordinate value, that is, the reproduction distance Z (first input value), output from the memory 30, as an address, and outputs data stored at the address as a propagation function phase constant (first intermediate value). The adder 96 receives the propagation function phase constant (first intermediate value) output from the memory 95, also receives the initial phase value P (second input value) output from the initial phase value generator 40, adds the propagation function phase constant and the initial phase value P, and outputs the addition result as a phase value (second intermediate value). The memory 97 has stored therein propagation function values, corresponding to respective phase values, receives the phase value (second intermediate value) output from the adder 96 as an address, and outputs data stored at the address as the propagation function value. The multiplier 92 receives the propagation function value output from the constant generator 91A, also receives the luminance value I (third input value) output from the memory 20, multiplies the propagation function and the luminance value I, and outputs a product value that is the multiplication result. The adder/subtractor 93 receives the product value output from the multiplier 92 and a hologram time series signal PDin (fourth input value), output and arriving from an element processor PE or a shift register SR of a preceding stage, performs addition/subtraction on the product value and the hologram time series signal PDin, and outputs a sum/difference value that is the addition/subtraction result. The register 94 receives and holds the sum/difference value output from the adder/subtractor 93 at a rising edge time of the clock signal PCLK and outputs the sum/difference value as a hologram time series signal PDout to an element processor PE or shift register SR at a subsequent stage.

The respective element processors PE_{j, i} (j=0 to n, i=0 to m) and the respective shift registers SRⱼ (j=1 to n) are cascade-connected via the hologram time series signal. That is, in each column constituted of (m+1) element processors, the hologram time series signal PDout output from an element processor PE_{j, i-1} is input as the hologram time series signal PDin into an element processor PE_{j, i} at a subsequent stage (j=0 to n, i=1 to m). The hologram time series signal PDout that is output from an element processor PE_{j-1, m} at a final stage of each column is input, via a shift register SRⱼ, into an initial stage element processor PE_{j, 0} of the next column as the hologram time series signal PDin (j=1 to n). The element processor PE_{0, 0} receives the value 0 as the hologram time series signal PDin. The element processor PE_{n, m} outputs the result of the convolution integration operation as the hologram time series signal. The D/A converter 50 receives the value (digital value) that is the result of the convolution integration operation and converts this value into an analog value.

As the propagation function phase constants stored in the memory 95 of each element processor PE_{j, i} (j=0 to n, i=0 to m), values are stored in correspondence to the respective coordinate values Z in accordance with the discrete position on the hologram surface that is associated with the element processor. Thus, each element processor PE_{j, i} (j=0 to n, i=0 to m) determines the phase value according to the coordinate value Z and the initial phase value P by means of the adder 96, determines the propagation function value in accordance with the phase value by means of the memory 97, multiplies the propagation function value and the luminance value I by means of the multiplier 92, performs addition/subtraction on the multiplication result and the hologram time series signal PDin by means of the adder/subtractor 93, and outputs the sum/difference value that is the result of the addition/subtraction from the register 94 in synchronization with the clock signal. That is, within the period of one cycle of the clock signal, the products of the propagation function value and the luminance value corresponding to a single reproduction point are added at once, thus enabling the convolution integration operation to be performed at high speed. The number of the reproduction points only has the number of addresses of each of the memory 20 and the memory 30 as the upper limit and is thus irrelevant to the calculation time and the convolution integration operation ends within a screen scanning time. The phase constants stored in the memory 95 and the propagation function values stored in the memory 97 of each element processor PE_{j, i} (j=0 to n, i=0 to m) shall now be described in detail. To simplify the following description, a distance Lo between a reproduction point and the hologram surface shall be approximated as an integer multiple of a wavelength λ of an illumination light used for reproduction. When r is a radial distance from a center of a zone plate on a hologram surface, a distance rb(Lo, k) of a k-th order bright portion of the zone plate is expressed by formula (1) shown below, and a distance rd(Lo, k) of a k-th order dark portion of the zone plate is expressed by formula (I) shown below. If P is an interval of discrete positions on the hologram surface, a condition for a zone plate to be resolvable is expressed by formula (3) shown below.

rb(Lo,k)=(2·L·k·λ·k²·λ²)^{1/2} (1)

rd(Lo,k)=(2·Lo·(k+0.5)·λ+(k+0.5)²·λ²)^{1/2} (2)

rd(Lo,k)−rb(Lo,k)>P (3)

A maximum order k−kmax of a resolvable zone plate bright portion is determined from the above. The maximum radius of a resolvable zone plate bright portion is rb(Lo, kmax). Because the maximum radius rb(Lo, kmax) of a bright portion is a physical quantity, it is divided by the interval (pixel pitch) P of discrete positions on the hologram surface to determine a lattice point distance r(Lo) by the following formula (4).

r(Lo)=rb(Lo,kmax)/P (4)

The propagation function on the hologram surface that corresponds to the distance Lo is determined as follows. x and y are deemed to be lattice point coordinate numbers on the hologram surface and the value of each of x and y is deemed to be an integer, for example, in a range of −254 to +255. A distance L(X, Y, Lo) between a reproduction point and a single point (P·X, P·Y) on the hologram surface is expressed by formula (5) shown below. A phase phs(X, Y, Lo) corresponding to the distance L(X, Y, Lo) is expressed by formula (6) shown below. Here int is an operator symbol for forming an integer by truncating a fractional part.

L(X,Y,Lo)=(P²·X²+P²·Y²+Lo²)^{1/2} (5)

phs(X,Y,Lo)=2π{L(X,Y,Lo)/λ−(int)(L(X,Y,Lo)/λ)} (6)

When a propagation function Zp(X, Y, Lo) is to be expressed as a complex number, a real component is determined by formula (7) shown below and an imaginary component is determined by formula (8) shown below. If the propagation function Zp(X, Y, Lo) is to be expressed as a real number, just formula (7) is calculated. Formula (9) shown below may also be applied in consideration of the maximum radius r(Lo) of the zone plate on the hologram surface. Also, in each of formulas (7) and (8), the factor 1/L(X, Y, Lo) of the cos function or sin function may be omitted and replaced by the value 1.

Zp(X,Y,Lo)={1/L(X,Y,Lo)]·cos [phs(X,Y,Lo)} (7)

Zp(X,Y,Lo)={1/L(X,Y,Lo)]·sin [phs(X,Y,Lo)} (8)

Zp(X,Y,Lo)=0 when (X²+Y²)^{1/2}>r(Lo) (9)

In the following description, the factor 1/L(X, Y, Lo) shall be omitted. Also, with Pm being an initial phase value P of an m-th bright point on the reproduction image, the real component of formula (7) shall be expressed as shown in formula (10) below and the imaginary component of formula (8) shall be expressed as shown in formula (II) below.

Zp(X,Y,Lo)=cos {phs(X,Y,Lo)+Pm} (10)

Zp(X,Y,Lo)=sin {phs(X,Y,Lo)+Pm} (11)

The initial phase value Pm of the m-th bright point on the reproduction image is stored in the initial phase value generator 40. The phase constant phs(X, Y, Lo), expressed by formula (6), is stored in the memory 95 of the element processor PE. Here, because each element processor PE_{j, i} (j=0 to n, i=0 to m) is already associated with a discrete position, that is, a pair of coordinate values X, Y on the hologram surface, it suffices that just phase constants corresponding to respective values of the distance Lo be stored in each memory 95. That is, the memory 95 receives just the distance Lo as an address and outputs, from among the stored phase constants, the phase constant stored at the address.

The propagation function values Zp(X, Y, Lo), expressed by formula (10) or formula (II), are stored in the memory 97 of the element processor PE. That is, a conversion table for performing cos function operations and sin function operations is stored in the memory 97. The memory 97 receives the sum value of the phase constant phs(X, Y, Lo), output from the memory 95, and the initial phase value Pm (the result of addition by the adder 96) and outputs a cos function value and a sin function value, corresponding to the input value, as the propagation function value Zp.

Also, to perform the convolution integration operation normally, the positional relationship of the respective element processors PE and the relationship of the discrete positions on the hologram surface are inverted with respect to each other in the respective directions of the X-axis and the Y-axis. Specifically, if each of the integers n and m is an even number, the propagation function Zp(n/2-j, m/2−i, Lo) is stored in the memory 97 of the element processor PE_{j, i} (j=0 to n, i=0 to m).

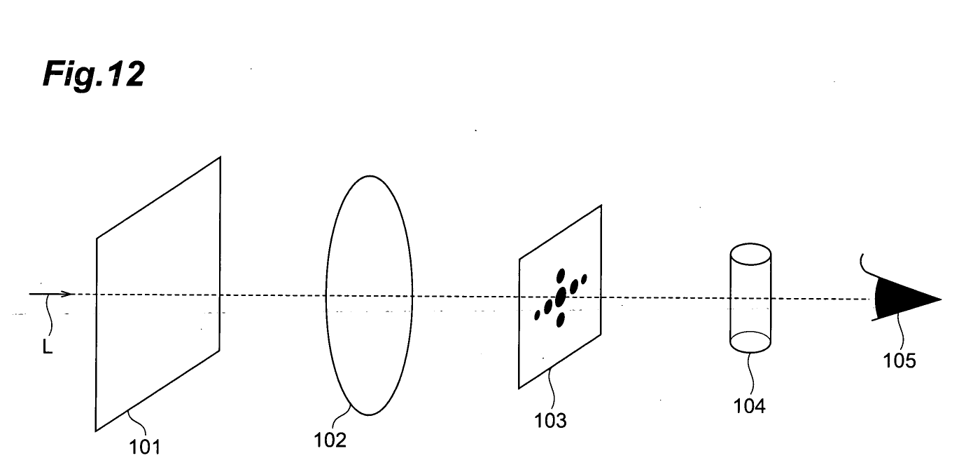

The following is performed in storing the luminance values I in the memory 20, storing the coordinate values Z in the memory 30, and the initial phase values P in the initial phase value generator 40. That is, so that a central component of the propagation function is provided in the hologram time series signal, data is stored in each of the memory 20, the memory 30, and the initial phase value generator 40 of each element processor PE upon shifting by just −n/2 in the row direction and by just −m/2 in the column direction in consideration of delay. Also, in order to prevent foldback of the propagation function at the hologram surface, the value 0 is stored as the data in each of the memory 20, the memory 30, and the initial phase value generator 40 of each of the element processors PE_{j, i} (V−(n+1)≦j≦V−1 or H-(m+1)≦i≦H−1). An example shall now be described. With this example, in using a hologram prepared as described above to reproduce and display a reproduction image by means of the reproduction optical system of FIG. 12, a hologram is written into a two-dimensional spatial optical modulation element, and illumination light is illuminated onto the two-dimensional spatial optical modulation element to perform display via a lens.

Reproduction lengths Lo were set in 0.4 mm increments in a range from 0 mm to 10.2 mm and 256 propagation functions were prepared in correspondence to the respective distances Lo. The wavelength λ of the illumination light for reproduction was set to 0.6328 μm. A two-dimensional spatial optical modulation element (LSM18HDA01M, made by Hitachi Displays, Ltd.), with a pixel pitch P of 8.1 μm and a pixel number of 1920×1080, was disposed at a position 150 mm in front of a lens with a focal length of 200 mm. The propagation functions were those of cosine zone plate halves, and in consideration of the maximum radius of the propagation functions, the number of element processors PE was set to 128×64.

8-bit data were respectively used as the luminance values I, the coordinate values Z, and the initial phase values P, output from the memory 20, the memory 30, and the initial phase value generator 40. 8-bit data with an upper limit of 2π were used as the phase constants output from the memory 95 of each element processor PE. As the phase value output from the adder 96, an upper bit of the addition result was discarded to provide 8-bit data with an upper limit of 2π. 8-bit data were used as the propagation function values output from the memory 97. As the data output from the multiplier 92, the lower eight bits of the multiplication result were discarded to provide 8-bit data. 16-bit data were used as the hologram time series signals PDin, input into the adder/subtractor 93, and 16-bit data were used as the hologram time series signals PDout, output from the register 94.

The convolution integrator with the above arrangement was realized by an FPGA (Field Programmable Gate Array). The circuit scale of each element processor PE was approximately 400 logic elements, and it was possible to integrate approximately 400 element processors, including other peripheral circuits, in an FPGA having 180,000 logic elements and 9M bits of memory. A convolution integrator that can prepare a computer generated hologram in real time was arranged using approximately 20 such FPGAs.

In a case of using a two-dimensional spatial optical modulation element that can control both the amplitude and the phase, two sets each of the element processors PE_{j, i}=(j to n, i=0 to m) and the shift registers SRⱼ (j=1 to n) in the arrangement shown in FIG. 1 are prepared, one set is made to generate the cosine hologram time series signals, the other set is made to generate sine hologram time series signals, and these are converted into hologram time series signals of amplitude and phase using a lookup table.

### Second Embodiment

A second embodiment of the convolution integrator according to the present invention shall now be described. In comparison to the convolution integrator according to the former first embodiment, the convolution integrator according to the second embodiment is substantially the same in the overall arrangement shown in FIG. 1 but differs in that the initial phase values stored in the initial phase value generator 40 are 2-bit data as described later and also differs in the arrangement of each element processor PE.

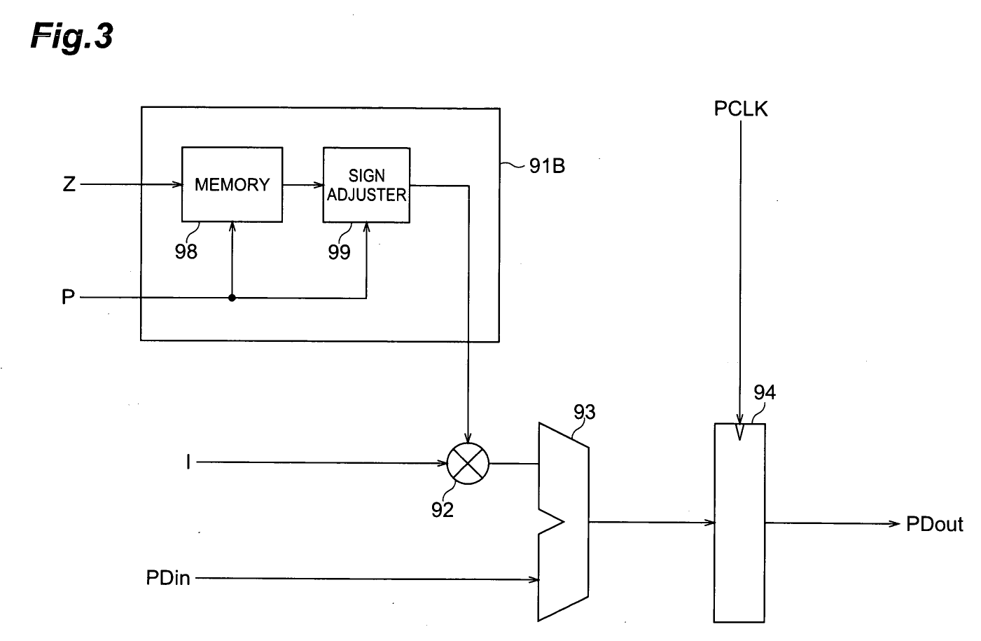

FIG. 3 is a block diagram of an element processor PE in the convolution integrator according to the second embodiment. The element processor PE has a constant generator 91B, the multiplier 92, the adder/subtractor 93, and the register 94. The constant generator 91B receives the coordinate value, that is, the reproduction distance Z (first input value) output from the memory 30, also receives the initial phase value P (second input value) output from the initial phase value generator 40, generates a predetermined value based on the reproduction distance Z and the initial phase value P, and outputs the predetermined value as a propagation function value. The multiplier 92, the adder/subtractor 93, and the register 94 are the same as those of the first embodiment.

The constant generator 91B includes a memory 98 and a sign adjuster 99. The memory 98 receives the coordinate value, that is, the reproduction distance Z (first input value) output from the memory 30, also receives an upper bit of the initial phase value P (second input value) output from the initial phase value generator 40, and outputs an intermediate value according to the reproduction distance Z and the upper bit of the initial phase value P. The sign adjuster 99 receives the intermediate value output from the memory 98, also receives a lower bit of the initial phase value P (second input value) output from the initial phase value generator 40, adjusts the sign of the intermediate value according to the value of the lower bit of the initial phase value P, and outputs the sign-adjusted intermediate value as the propagation function value.

In the present embodiment, the initial phase value P is a 2-bit data and its (upper bit, lower bit) is expressed by (0, 0), (0, 1), (1, 0), or (1, 1). When the addition theorem of trigonometric functions, expressed by formula (12) shown below, is applied, the propagation function Zp is expressed by a formula among formulae (13) to (16). Thus, by preparing propagation functions Zp of formulae (13) and (16), respectively, and changing the signs of these propagation functions, the propagation functions Zp of formulae (14) and (15), respectively, can be obtained.

cos(θ+Pm)=cos θ cos Pm−sin θ sin Pm (12)

Zp(X,Y,Lo)=+{1/L(X,Y,Lo)}·cos {phs(X,Y,Lo)} (13)

Zp(X,Y,Lo)=−{1/L(X,Y,Lo)}·sin {phs(X,Y,Lo)} (14)

Zp(X,Y,Lo)=−{1/L(X,Y,Lo)}·cos {phs(X,Y,Lo)} (15)

Zp(X,Y,Lo)=+{1/L(X,Y,Lo)}·sin {phs(X,Y,Lo)} (16)

Thus as the initial phase values P, 2-bit data are stored in the initial phase value generator 40, an initial phase value P, corresponding to the coordinate values X and Y output from the counter 10, is output from the initial phase value generator 40, and this initial phase value P is input into the respective element process ors.

The memory 98 receives a 9-bit address and outputs an 8-bit data. The 9-bit address that is input into the memory 98 includes eight bits of the coordinate value Z, output from the memory 30, and an upper one bit of the initial phase value P output from the initial phase value generator 40. The 8-bit data that is output from the memory 98 is a propagation function value Zp that is expressed by either formula (13) or (16) in accordance with the upper one bit of the input initial phase value P.

The sign adjuster 99 receives the propagation function value Zp output from the memory 98, also receives the lower bit of the initial phase value P output from the initial phase value generator 40, and outputs the input propagation function value Zp upon adjusting the sign thereof in accordance with the value of the lower bit of the initial phase value P. For example, the sign adjuster 99 outputs the input propagation function value Zp upon inverting the sign thereof if the value of the lower bit of the initial phase value P is 0 and outputs the input propagation function value Zp as it is if the value of the lower bit of the initial phase value P is 1.

The propagation function value Zo is generated and output according to the reproduction distance Z and the initial phase value P by the constant generator 91B in the present embodiment as well. The respective operations of the multiplier 92, the adder/subtractor 93, and the register 94 are the same as those of the first embodiment.

### Third Embodiment

A third embodiment of the convolution integrator according to the present invention shall now be described. In comparison to the convolution integrator according to the former first embodiment, the convolution integrator according to the third embodiment is substantially the same in the overall arrangement shown in FIG. 1 but differs in the arrangement of the initial phase value generator 40 as shall be described below.

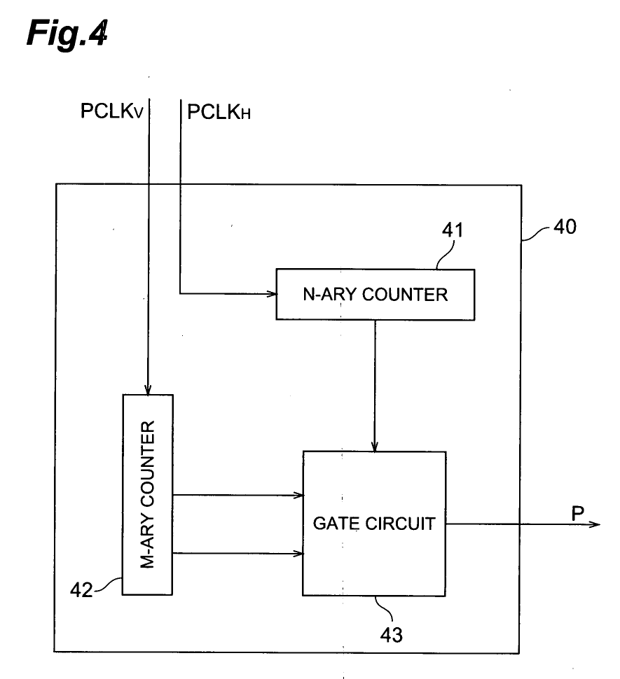

FIG. 4 is a block diagram of the initial phase value generator 40 in the convolution integrator according to the third embodiment. The initial phase value generator 40 includes an n-ary counter 41, an m-ary counter 42, and a combinational gate circuit 43.

The n-ary counter 41 receives a horizontal scan clock signal PCLK_{H} that is a portion of the clock signal PCLK input into the counter 10 shown in FIG. 1, counts the number of pulses of the clock signal PCLK_{H}, and outputs the count value to the combinational gate circuit 43. The m-ary counter 42 receives a vertical scan clock signal PCLK_{V} (carry-out of the horizontal scan clock signal PCLK_{H}) that is a portion of the clock signal PCLK input into the counter 10 shown in FIG. 1, counts the number of pulses of the clock signal PCLK_{V}, and outputs the count value to the combinational gate circuit 43.

The combinational gate circuit 43 receives the count value data output from the n-ary counter 41, also receives the count value data output from the m-ary counter 42, and generates and outputs an initial phase value P based on data of certain bits of the count value data. For example, let the n-ary counter 41 be a quaternary counter and the m-ary counter 42 be an octonary counter. The combinational gate circuit 43 then generates and outputs the initial phase value P based on the 3-bit data excluding the lowermost bit of the 4-bit data output from the n-ary counter 41 and the 7-bit data excluding the lowermost bit of the 8-bit data output from the m-ary counter 42.

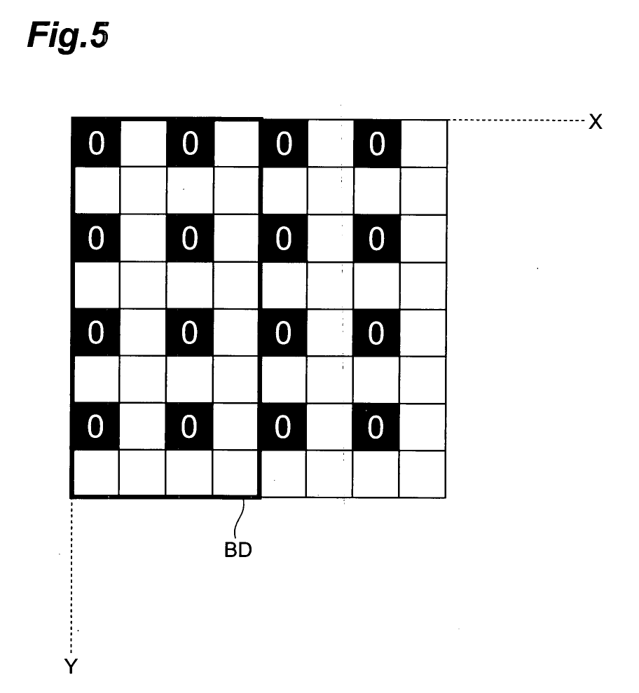

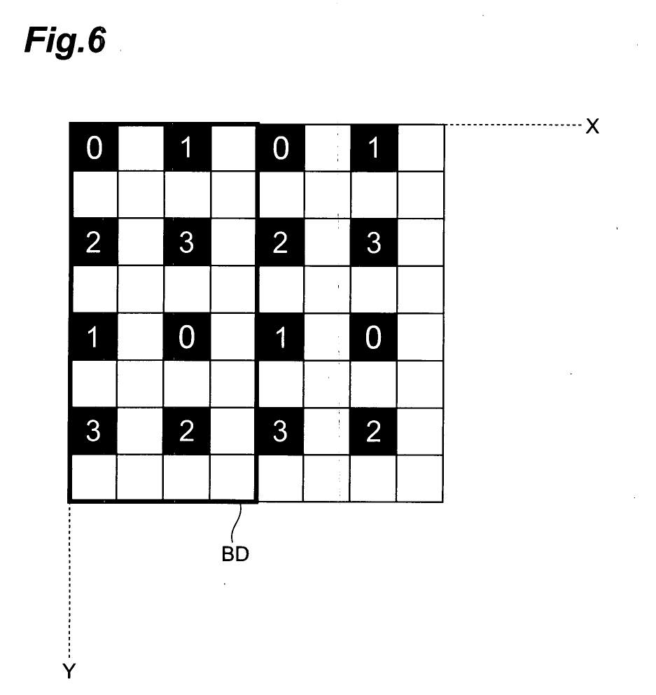

The memory 20 that outputs the luminance values I outputs the luminance values I of respective positions of an image reproduced from a spatial optical modulation element so that bright point positions in the reproduced image are periodically positioned at twice a pixel pitch of the spatial optical modulation element in, each of the X direction and the Y direction as shown in FIGS. 5 and 6. For this purpose, the memory 20 stores non-zero luminance values I at periodic positions in each of the X-direction and the Y-direction and stores a luminance value of 0 at other positions.

That is, in each of FIGS. 5 and 6, each position in the image reproduced from the spatial optical modulation element is indicated by an individual minimum unit square, positions of bright points that have luminance values in the reproduction image are indicated by black-filled squares, and a range of a single period of the luminance value distribution in the reproduction image is indicated by a thick-line, rectangular frame BD. At the positions of the bright points that have luminance values in the reproduction image (the black-filled squares), the numeral “0” indicates a basic value of the initial phase value, the numeral “1” indicates that the initial phase value is “basic value+π/2,” the numeral “2” indicates that the initial phase value is “basic value+π,” and the numeral “3” indicates that the initial phase value is “basic value+3π/2.” Whereas the initial phase values of the bright points having luminance values are fixed in FIG. 5, in FIG. 6, the bright points are set periodically at twice the pixel pitch of the spatial optical modulation element in the X direction and are set periodically at four times the pixel pitch of the spatial optical modulation element in the Y direction.

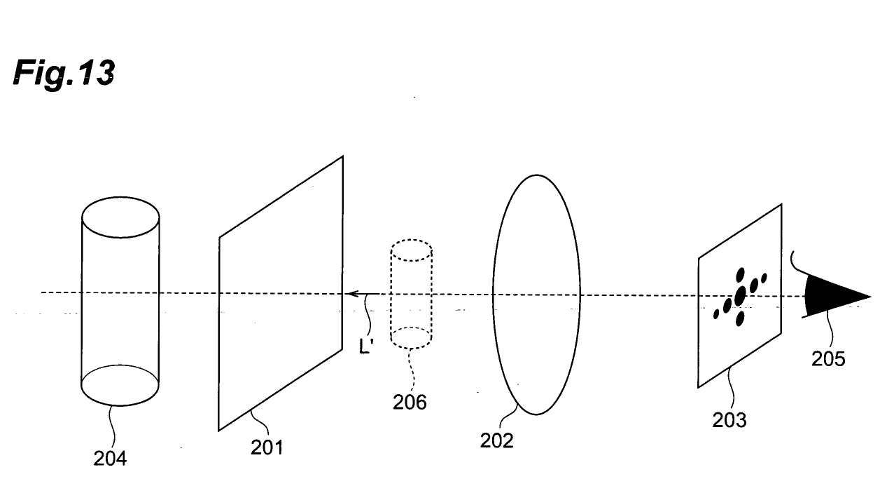

Such a periodic bright point positioning and initial phase value distribution are favorable in cases, such as the reproduction optical system shown in FIG. 13, where uniformalization of spectral light does not have to be performed rigorously. With the reproduction optical system shown in FIG. 13, reproduction lengths Lo were set in 0.4 mm increments in a range from 0 mm to 10.2 mm and 256 propagation functions were prepared in correspondence to the respective distances Lo. The wavelength λ of the illumination light for reproduction was set to 0.635 μm. A reflection type two-dimensional spatial optical modulation element (LSM18HDA01M, made by Hitachi Displays, Ltd.), with a pixel pitch P of 8.1 μm and a pixel number of 1920×1080, was disposed at a position 40 mm in front of a lens with a focal length of 40 mm. The propagation functions were those of cosine zone plate halves, and in consideration of the maximum radius of the propagation functions, the number of element processors PE was set to 128×64.

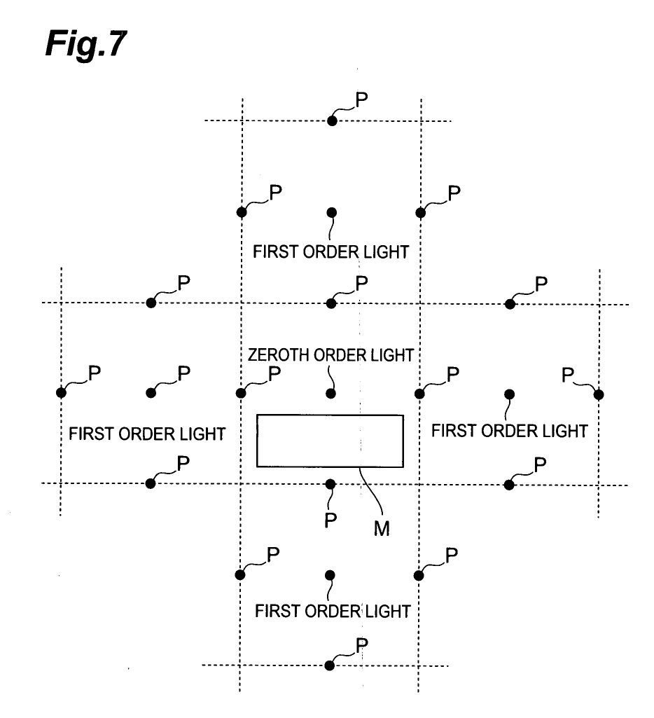

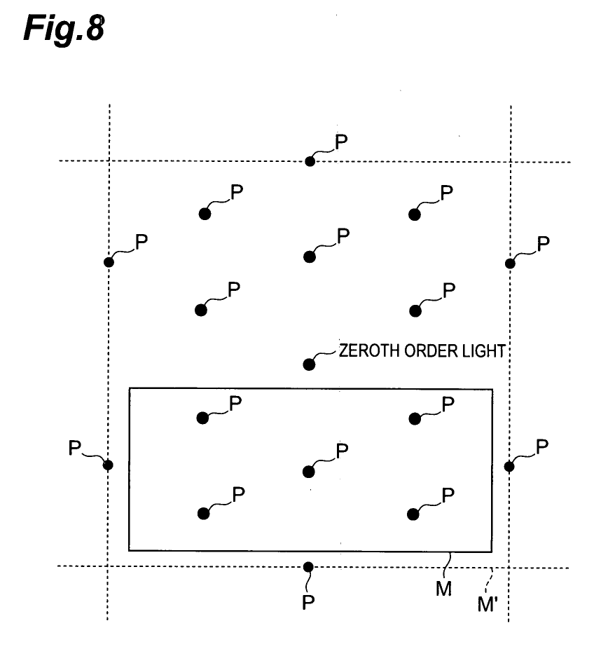

FIG. 7 is a diagram of a light intensity distribution at a rear focal plane of the lens in the case of the bright point intervals and the initial phase values shown in FIG. 5. FIG. 8 is a diagram of a light intensity distribution at the rear focal plane of the lens in the case of the bright point intervals and the initial phase values shown in FIG. 6. In each of FIGS. 7 and 8, a solid-line rectangular frame indicates a mask opening M that transmits reproduction light components, each broken-line rectangular frame indicates a range of a region in which wavefronts, conjugate to the reproduction light components that arrive at the opening, arrive, a central black circle indicates a position at which a zeroth order light component arrives, and black circles P indicate peak positions of arriving reproduction light components (object light components).

With the bright point interval and fixed initial phase value shown in FIG. 5, high-peak black circles P are present at positions intermediate the zeroth order diffraction light component and the first order diffraction light component in both the X-direction and the Y-direction in the light intensity distribution at the rear focal plane of the lens as shown in FIG. 7. The reproduction image in this case is not preferable for the following two reasons. Firstly, as the intensities of the respective bright points that make up the three-dimensional reproduction image become more uniform, and in particular, as a reproduction image becomes closer to a plane and fewer in patterns, light peaks become more localized in the light intensity distribution at the rear focal plane of the lens, the reproduction light components do not pass through the mask opening M within the zeroth order plane, and a three-dimensional reproduction image becomes unobservable. This means that the bright points must be culled further and that the definition of the spatial optical modulation element cannot be used effectively. Secondly, even if the mask opening M is shifted to make the reproduction light components pass, because the zeroth order light components and the first order light components are overlapped in the passing reproduction light, two types of reproduction light that differ in propagation direction pass and thus two reproduction images that differ in reproduction position become observed overlappingly.

Meanwhile, in the case of the bright point interval and initial phase values shown in FIG. 6, because, in the light intensity distribution at the rear focal plane of the lens, the light that passes through the mask opening M is constituted of five localized reproduction light components as shown in FIG. 8, the light is made incident on the entirety of a pupil of an observer set near the mask opening M and forms a single reproduction image on the retina. Thus, the degree of formation or non-formation of an image on the retina by control of the thickness of the crystalline lens of the eye becomes high in comparison to a case where a single localized light component passes through just the center of the pupil and the perspective sensation obtained by the observer can thus be improved.

### INDUSTRIAL APPLICABILITY

The present invention can be used as a convolution integrator.

1. A convolution integrator comprising a plurality of practically cascade-connected element processors and
wherein each of the plurality of element processors comprises:
a constant generator, receiving a first input value and a second input value, generating a predetermined value based on the first input value and the second input value, and outputting the predetermined value;
a multiplier, receiving the predetermined value, output from the constant generator, and a third input value, multiplying the predetermined value and the third input Value, and outputting a product value resulting from the multiplication;
an adder/subtractor, receiving the product value, output from the multiplier, and a fourth input value, performing addition/subtraction of the product value and the fourth input value, and outputting a sum/difference value resulting from the addition/subtraction; and
a register, receiving, holding, and outputting the sum/difference value output from the adder/subtractor; and
the sum/difference value, output from the register of an element processor that is cascade-connected at a preceding stage, is input as the fourth input value into the adder/subtractor of an element processor at a subsequent stage to perform convolution integration of the predetermined value and the third input value.

2. The convolution integrator according to claim 1, wherein
the constant generator comprises:
a first memory, receiving the first input value and outputting a first intermediate value according to the first input value;
an adder, receiving the first intermediate value, output from the first memory, and the second input value, adding the first intermediate value and the second input value, and outputting a second intermediate value that is the result of the addition; and
a second memory, receiving the second intermediate value, output from the adder, and outputting the predetermined value according to the second intermediate value.

3. The convolution integrator according to claim 1, wherein
the second input value is a 2-bit data, and
the constant generator comprises:
a memory, receiving the first input value and an upper bit of the second input value and outputting an intermediate value according to the first input value and the value of the upper bit of the second input value; and
a sign adjuster, receiving the intermediate value, output from the memory, and a lower bit of the second input value, adjusting the sign of the intermediate value according to the value of the lower bit of the second input value, and outputting the sign-adjusted intermediate value as the predetermined value.

4. The convolution integrator according to claim 1, being used for preparing a computer generated hologram and wherein the first input value is a reproduction distance, the second input value is an initial phase value, the predetermined value output from the constant generator is a propagation function value that is in accordance with the reproduction distance and the initial phase value, the third input value is a luminance value, and the fourth input value and the convolution integration result are hologram time series signals.

5. The convolution integrator according to claim 1, further comprising:
an address generator, successively generating and outputting a plurality of addresses;
a first signal value generator, receiving an address output from the address generator and outputting a first signal value, that is in accordance with the address, to each of the plurality of element processors;
a second signal value generator, receiving an address output from the address generator and outputting a second signal value, that is in accordance with the address, to each of the plurality of element processors; and
a third signal value generator, receiving an address output from the address generator and outputting a third signal value, that is in accordance with the address, to each of the plurality of element processors.

6. The convolution integrator according to claim 5, wherein
the second signal value generator comprises: a combinational gate circuit, generating and outputting the second signal value based on a data of a certain bit of the address output from the address generator.
